(19) United States
(12) Patent Application Publication
(10) Pub. No.: US 2005/0209885 A1
(43) Pub. Date: Sep. 22, 2005

(54) Automatic processing and management of referrals of specialty healthcare services

(76) Inventors: Michael Lamb, Rock Tavern, NY (US); Kimberly Stavrinakis, Richmond, VT (US); Ronald Keen, Shelburne, VT (US); Erik Preiss, Underhill, VT (US)

Correspondence Address: FENWICK & WEST LLP, SILICON VALLEY CENTER, 801 CALIFORNIA STREET, MOUNTAIN VIEW, CA, 94041, US

(21) Appl. No.: 10/997,435

(22) Filed: Nov. 24, 2004

Related U.S. Application Data
(60) Provisional application No. 60/525,550, filed on Nov. 26, 2003.

(51) Int. Cl. G06F 17/60

(52) U.S. Cl. 705/2

(57) ABSTRACT

According to various embodiments, methods and systems are provided for facilitating and managing communications between healthcare service referrers and healthcare service providers. Such communications are transacted via digital networks in connection with a healthcare information system. Referral of various diagnostic and therapeutic specialties is tracked from the initiation by the referrers to the completion of the services by the specialty service providers. Validation of insurance authorization is performed automatically if needed. Reports on the results of a requested specialty service as well as intermediate recommendations are made available to the referrer or other relevant entities upon completion of the service.

### CROSS REFERENCE TO RELATED APPLICATIONS

This application claims the benefit of U.S. Provisional Application No. 60/525,550, entitled “Digital Management of Referral and Provision of Healthcare Services”, filed Nov. 26, 2003, which is incorporated by reference herein.

### BACKGROUND

1. Field of the Invention

This invention relates in general to healthcare services referral and management, and more particularly to automatically initiating and tracking referrals of specialty healthcare services as well as tracking intermediate and final results of the specialty services.

2. Background Art

When certain specialty services (whether a diagnostic test or therapeutic procedure) are needed for patient care, it typically takes a series of phone calls, conversations, and the processing of stacks of written notes or printed forms before a medical order for the services is placed by a healthcare referrer, such as a primary care doctor. This manual process is both error-prone and inefficient. It typically takes anywhere from ten to thirty minutes for a referring provider to prepare a patient's order. This time is spent collecting patient demographics, insurance information, and medical records and obtaining insurance authorizations. Much of the communication is done by telephone. Studies show that for a referring provider that is scheduling an average of 10 medial or diagnostic procedures per day it takes an average of three hours per day and 850 hours per year. Missed phone calls, voice mails, and misplaced paper are commonplace and they represent significant waste of human resources. Inefficiency in communication among healthcare referrers, healthcare specialty providers, insurance specialists, and any other relevant parties directly translates into inefficiency in the provision of patient care.

There are software solutions available today that attempt to address this problem. Physician order entry systems are among them. These systems focus on order creation, and are typically confined to clinical systems or organizations from which a referring provider is operating. The primary objective of these systems is to capture a clinical order and validate its contents for medical accuracy and practice redundancies. These systems, however, do not focus on monitoring intermediate and final results of the order completion.

Other existing software solutions allow for the display of medical images and diagnostic reports over a web interface. These solutions are typically based on the results of the medical or diagnostic procedure. They are not capable of, for example, placing a medical order and tracking the subsequent follow-up orders that are the recommended course of actions given the results of the services subscribed by the initial order. Thus, none of the existing automated solutions are capable of monitoring the entire life of a specialty order, from its inception to the final completion of the service.

Accordingly, there is a need for a more efficient mechanism for placing a specialty order and monitoring the results of the completion of the order.

### DISCLOSURE OF THE INVENTION

The above need is met by a referral order management system that captures an initial specialty order from a referral provider office, tracks the relevant patient information regarding the order from a specialty department office, provides automated alerts to physicians and other healthcare professionals at the referral provider office when new order information is available, provides reports on the results of a requested specialty service and follows up with the subsequent recommendations. Such a system facilitates the communications between the referring provider office and the specialty group or department that will be performing the diagnostic or therapeutic procedure.

In one embodiment, the referral order management system communicates with a referring provider office that creates a specialty order and a specialty department office that will be performing diagnostic or therapeutic procedures indicated in the order and providing updates on the order to the referral order management system. The referral order management system also communicates with an insurance carrier system that services preauthorization requests initiated by the referral order management system. The referral order management system notifies the referring provider office and a specialty department office of the events that are raised as the result of the actions performed on the specialty order. For example, the referral management system provides a notification when a new order is created, when a status of the order is updated, or when the specialty department office has posted results of the procedure indicated in the order.

In one embodiment, the referral order management system executes various engines to perform the functionality for receiving an initial specialty order, tracking and capturing the relevant patient information regarding the order and providing automatic notifications about the status of the order. These engines include an order processing engine, an eligibility and preauthorization engine, and a notification engine. The order processing engine receives a specialty order from the referral provider office, preferably validates the received order, schedules a procedure indicated in the order, and automatically stores the order.

The notification engine listens to events that are triggered as the result of the actions performed on the order. In one implementation, the notification engine notifies the referring provider office and the specialty department office of the events, thereby allowing a referring provider office and a specialty department office to monitor the status of the specialty order in real time.

The eligibility and pre-authorization engine of the referral order management system receives a notification from the notification engine that the new order is stored, preferably determines whether the procedure indicated in the order requires insurance pre-authorization, and sends a request for pre-authorization to an insurance carrier system. The eligibility and pre-authorization engine then receives the pre-authorization information from the insurance carrier system and persists the information into the system. The eligibility and pre-authorization engine also uses eligibility rules to verify whether the procedure indicated in the specialty order is eligible for reimbursement by the insurance carrier.

Thus, the referral order management system of the present invention tracks the entire life of a specialty referral, from the initial order of the service to the final completion of the service. Such comprehensive digital referral management enables significant reduction of ad hoc or manual communications among specialty service providers, referrers, and patients in order to set up and complete the required specialty services.

### BRIEF DESCRIPTION OF THE DRAWINGS

FIG. 1 is a high-level diagram illustrating an environment utilizing an embodiment of the present invention.

FIG. 2 is a block diagram of the referral order management system.

FIG. 3 is a block diagram illustrating a more detailed view of a data store of the referral order management system.

FIG. 4 is an event diagram of a method for ordering specialty services and tracking intermediate and final results of the specialty services.

FIG. 5 is a flow diagram of the steps performed by the eligibility and authorization engine within the referral order management system.

FIG. 6 is a flow diagram of the steps performed by the notification engine within the referral order management system.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

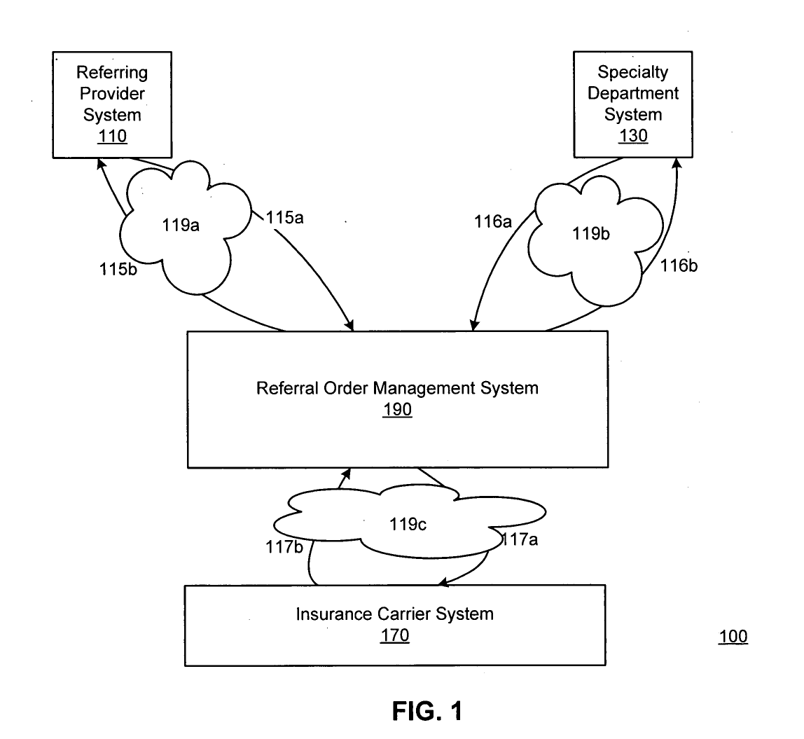

FIG. 1 is a high-level block diagram illustrating an environment 100 utilizing an embodiment of the present invention. The illustrated environment 100 includes a referral order management system 190, a referring provider system 110, a specialty department system 130, and an insurance carrier system 170.

Referring provider system 110 is a computer system associated with a referring provider's office (not shown in FIG. 1). In general, system 110 is an electronic device that allows end-users to interface with referral order management system 190. System 110 can be, for example, a personal computer system, a portable digital assistant (PDA), a cellular phone, or any other system capable of communicating with referral management system 190 and providing a user interface for displaying information. In one embodiment, system 110 executes a web browser (not shown) such as INTERNET EXPLORER from Microsoft Corp. of Redmond, Wash. Although only one referring provider system 110 is shown in FIG. 1 for purposes of clarity, embodiments of the present invention contemplate any number of referring provider systems interfacing with referral management system 190. Because in the preferred embodiment the invention is described in the medical context, end-users of system 110 can be physicians, referring provider office administrators, and other medical staff having access to system 110.

The referring provider's office uses system 110 to create a specialty referral order 115a to perform a medical procedure, such as a diagnostic test or a therapeutic procedure, on a patient. System 110 communicates the order 115a to referral order management system 190. As used herein, “a specialty order” is a documented direction to perform a medical procedure on a patient. It should be noted that “a specialty order”, “specialty referral order”, and “order” are used herein interchangeably. System 110 includes a user interface that allows a referring physician as well as other members of the referring provider's office staff to monitor the entire life of the order 115a, from the initial order to the final completion of the procedure listed in the order.

Specialty department system 130 is a computer system associated with a specialty service provider office (not shown in FIG. 1). The specialty service provider performs a medical procedure on a patient as indicated in the specialty referral order. System 130 is adapted to communicate to system 190 any updates 116a to the status of the order or results of the order. As used herein, “results” are findings ascertained during the performance of the medical procedure. The specialty department office uses system 130 to update the status of an order and add results of the procedure to the order. A specialty service provider office can be an outpatient clinic, a hospital, or any other medical facility that performs diagnostic or therapeutic procedures on patients.

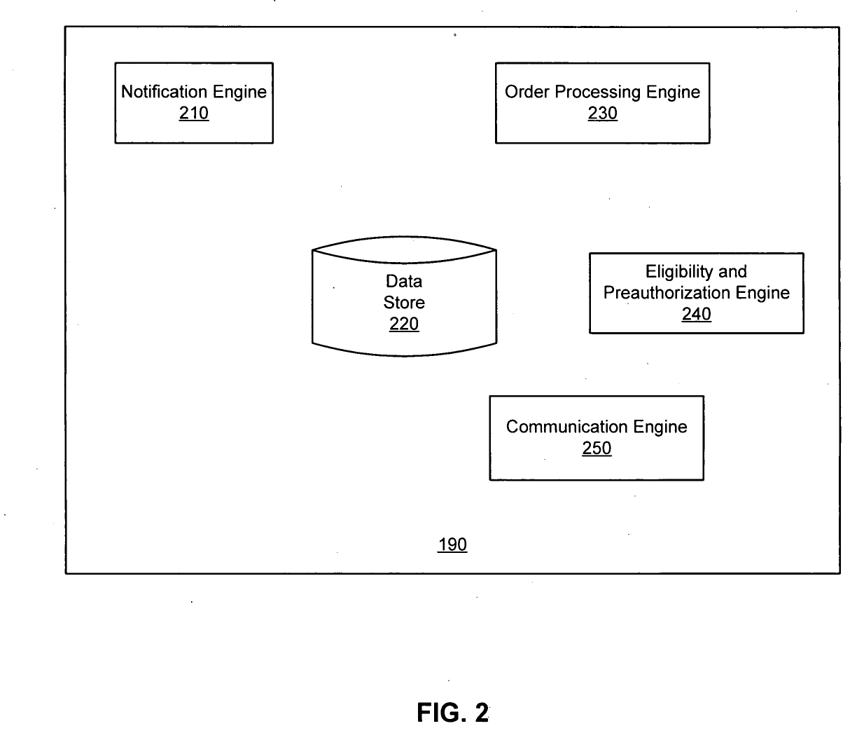

Referral order management system 190 is adapted to receive a specialty referral order 115a from system 110, process the order, perform eligibility and pre-authorization checks, track and capture relevant patient information regarding the specialty service, provide automated alerts 115b and 116b to system 110 and 130 respectively when an event occurs. An event can be triggered, for example, when a new order is created, an existing order is updated, results of the order have been submitted, or pre-authorization information is updated on the existing order. Thus, referral order management system 190 tracks and reports to systems 110 and 130 the status of the order at various points of the order processing. Such “real-time” monitoring enables accurate and efficient communications among all entities shown in FIG. 1 participating in the specialty order creation and execution. Various components of referral order management system 190 will be described in more detail below in reference to FIG. 2.

System 190 operates in several different modes according to the various embodiments depending on the conditions and needs of a given healthcare information setting. In one embodiment, the referral order management system 190 operates as a web-based system executed on a server (not shown in FIG. 1). In another embodiment, the referral order management system 190 is integrated into a third party system or framework (not shown in FIG. 1) or a third party portal, and thereby provides to the third party system the functionalities and advantages of automated tracking and management of information surrounding specialty service referral. In yet another embodiment, system 190 operates as a standalone system.

Whether standalone, embedded in another system, or integrated in a distributed network such as a web framework, the referral order management system 190 tracks the entire process of referring and completing various specialty therapeutic and diagnostic services and thereby allows for easy access of patient information.

The insurance carrier system 170 is a third party system adapted to receive insurance authorization requests 117a from system 190, perform insurance pre-authorization, and provide electronic pre-authorizations 117b to system 190 for procedures to be to performed on patients. System 170 is associated with an insurance carrier. Although only one system 170 is shown in FIG. 1, referral order management system 190 can be in communication with any number of insurance carrier systems 170.

In one embodiment, system 190 interfaces with systems 110, 130, and 170 via networks 119a, 119b, and 119c respectively. Networks 119a, 119b, and 119c allow the electronic exchange of data between system 190 and system 110 and 130. Networks 119a, 119b, and 119c can be the Internet. However, it will also be appreciated that communication networks 119a, 119b, and 119c can be any known communication network.

The data exchanged over networks 119a, 119b, and 119c can be represented in various formats, such as the hypertext markup language (HTML), the extensible markup language (XML), or any other representation.

Referral Order Management System

Turning now to FIG. 2, referral order management system 190 includes various engines to perform the functionality of receiving an initial specialty order, tracking and capturing the relevant patient information regarding the order and providing automatic notifications to referring provider system 110 and specialty department system 130 about the status of the order. These engines include an order processing engine 230, an eligibility and preauthorization engine 240, a communication engine 250, a notification engine 210, and a data store 220. In one embodiment, these engines are implemented as modules. As used herein, the term “module” refers to computer program code adapted to provide the functionality attributed to the module. The program code is embodied in a random access memory (RAM), a read-only memory (ROM) or other media.

Order processing engine 230 preferably receives a specialty order from system 110, validates the received order, schedules a procedure indicated in the order, and automatically stores the order in data store 220. An exemplary order includes, for example, an order ID, status of the order, patient ID, medical procedure ID, requested physician name, requested date and time when the procedure needs to be performed, and diagnosis. Other data, of course, may be included in the order.

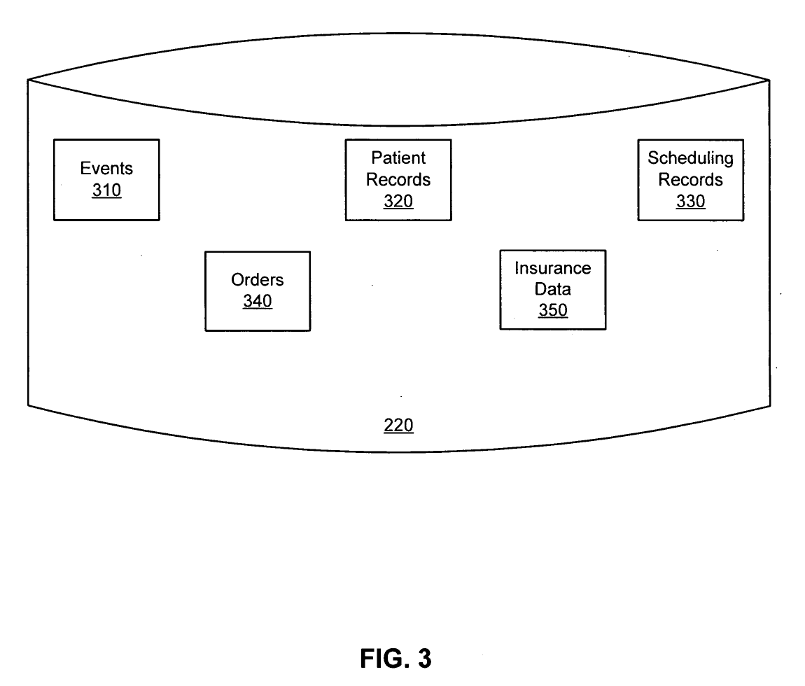

Data store 220 maintains data utilized by referral order management system 190 to perform its functionality. FIG. 3 is a block diagram of data store 220. Data store 220 maintains patient records 320, scheduling records 330 for medical procedures, specialty orders 340, and insurance data 350. Data store 220 also keeps track of events 310 that occur within the referral order management system 190. Data store 220 can be implemented, for example, as a relational database management system (RDMBS) and queries to the data store are accomplished via Standard Query Language (SQL).

Patient records 320 contain fields for storing data associated with a patient. A field can hold data in the form of numeric, textual, binary information, and any other data type adapted for storage in a data store 220. In one embodiment, a patient record includes patient identification information, such as patient ID, patient name, Social Security Number (SSN), date of birth, gender, patient insurance information and other patient identification information. Other data may be included as desired.

Scheduling records 330 include fields for storing data associated with scheduling a procedure. A typical record includes the following fields: an identification of a resource to be used to perform the procedure, date and time when the procedure can be scheduled to perform, and an order ID. As used herein, “a resource” is an entity that is utilized to perform the procedure. A resource can be a room, a piece of equipment, or a person utilized to perform the medical procedure.

Orders 340 are stored in association with patient records. An order includes, for example, an order ID, patient ID, status, procedure ID, diagnosis, Requesting Physician Name, Requested Date and Time, pre-authorization number, “require pre-authorization” flag, and “require advanced beneficiary notice (ABN)” flag. The ABN is a document that is required to be signed by a patient when the insurance carrier will not pay for the medical procedure. A typical ABN states that the patient has been notified that the insurance carrier will not reimburse the procedure, and the patient is responsible for the payment. In one embodiment, when the “require advanced beneficiary notice (ABN)” flag is set to FALSE, it indicates that the procedure indicated in the order will be reimbursed by the insurance carrier. If the flag is set to TRUE, it indicates that the insurance carrier will not reimburse for the procedure (and hence the patient is required to sign an ABN notice to this effect).

Insurance data 350 includes information related to various insurance carriers and various insurance plans offered by insurance carriers. This information includes, for example, procedure eligibility, pre-authorization requirements, supported electronic format, co-payment information, and other insurance carrier related information. Exemplary electronic formats supported by various insurance carriers are the Accredited Standards Committee (ASC) X12 protocol and the Health Level Seven (HL7) protocol.

Data store 220 also stores events 310 that are triggered as the result of the actions performed on the specialty order. Exemplary events are creation of a new order, updating of an existing order, receiving results of the existing order or receiving insurance pre-authorization of the existing order. In one embodiment, stored events have the following format: order ID, event code, and time stamp specifying the time when the event occurred. As will be described in greater details below, notification engine 210 shown in FIG. 2 uses events 310 to provide notifications to referring provider system 110 and specialty department system 130 about the events.

Referring again to FIG. 2, referral order management system 190 further executes notification engine 210. Engine 210 is adapted to listen to data events and perform an action in response to the data events. As previously described, various actions can trigger an event. For example, when order processing system 230 processes the received order and stores the order in data store 220, a NEWORDER event is triggered. Similarly, when specialty department system 130 communicates to referral order management system 190 results of the medical procedure or simply the status of the medical procedure, RESULTUPDATE and ORDERUPDATE are triggered. Likewise, when insurance authorization engine 240 communicates pre-authorization information to referral management system 190, a PREAUTHUPDATE event is triggered. These events are stored in data store 220 in association with the identification of the order that triggered the event and the time stamp. In one implementation, engine 210 notifies referring provider system 110, specialty department system 130, and eligibility and pre-authorization engine 240 of the events, thereby enabling a referring provider office and a specialty service department to monitor the status of the specialty order in real time. Notifications can be sent using COM interfaces, web service calls, or via XML or HL7 messages.

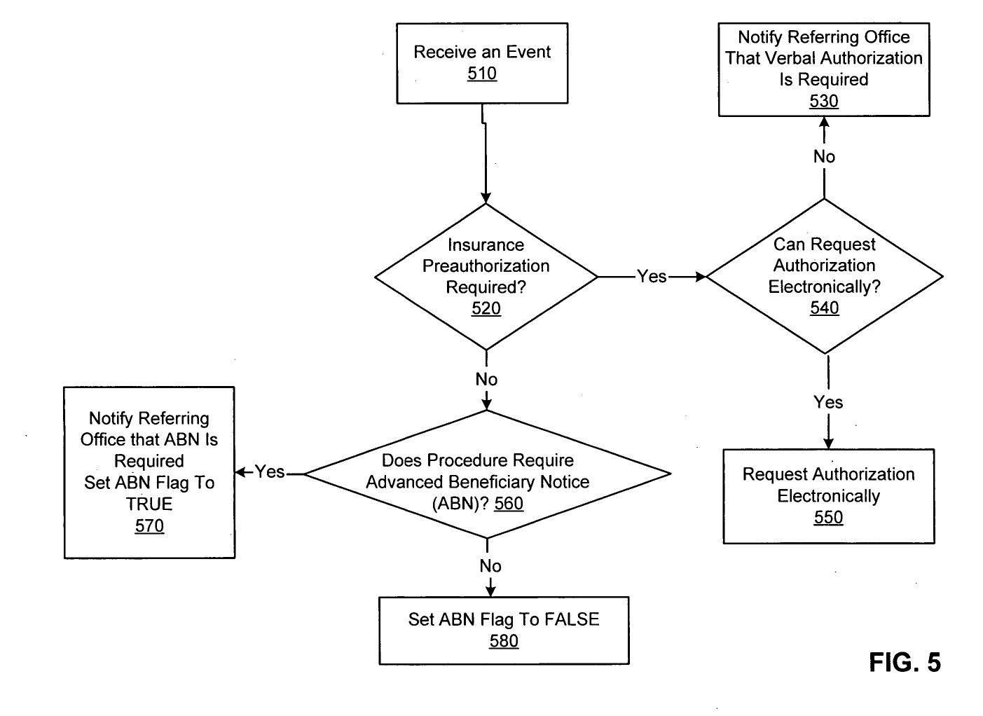

Referral order management system 190 further executes eligibility and preauthorization engine 240. Engine 240 receives notification from engine 210 that a new order is stored, determines whether the procedure indicated in the order requires insurance pre-authorization, and sends a request for pre-authorization to communication engine 250 if the pre-authorization is required. Engine 240 is further adapted to receive pre-authorization information, such as a preauthorization number, from communication engine 250, and store the information in data store 220. Engine 240 is also adapted to use eligibility rules to verify whether the procedure is eligible for reimbursement by the insurance carrier. FIG. 5 describes in more detail various steps performed by engine 240 to perform pre-authorization and eligibility processing. Although in the preferred embodiment of the present invention, engine 240 is a part of the referral order management system 190, other embodiments of the present invention may use third party subsystems for performing the functionality of engine 240. These systems include those provided by IDX Systems Corporation (www.idx.com) in Burlington, Vt. and WebMD (www.webmd.com) in Elmwood Park, N.J., among others.

Communication engine 250 is adapted to receive a pre-authorization request from engine 240, query insurance data 350 in data store 220 for an electronic format that is supported by the insurance carrier whose preauthorization is requested, format the data indicated in the request into the appropriate format, and send the request to system 170. Communication engine 250 is further adapted to receive pre-authorization information from system 170 and forward the information to engine 240. In one embodiment, the pre-authorization information includes a pre-authorization number. Engine 250 can be implemented as ConnectR application provided by IDX Systems Corporation of Burlington, Vt.

Methods of Operation

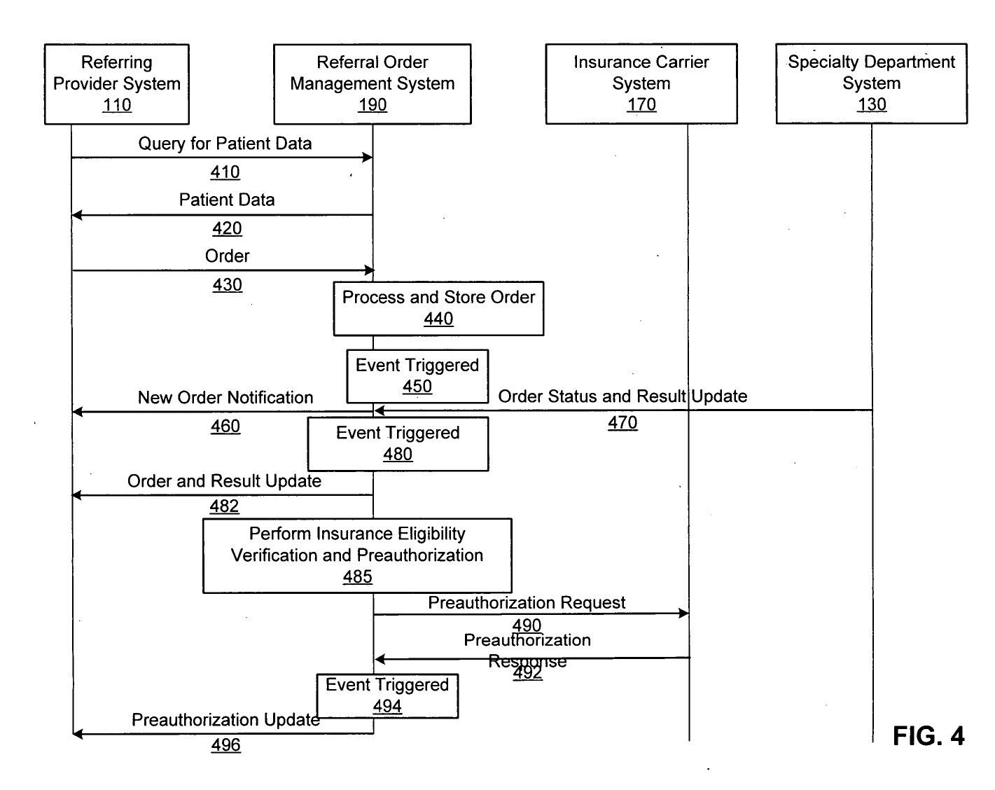

FIG. 4 is an event diagram illustrating exemplary transactions among referring provider system 110, referral order management system 190, insurance carrier system 170, and specialty department system 130. In FIG. 4, the above entities are listed across the top. Beneath each entity is a vertical line representing the passage of time. The horizontal arrows between the vertical lines represent transactions between the associated entities. It should be noted that not every transaction is shown in FIG. 4. In other embodiments of the present invention, the order of the transactions can vary.

Initially, when a referring provider office (not shown in FIG. 4) creates a new order for a medical procedure for a patient, the office causes system 110 to send a query 410 to data store 220 within system 190 for data associated with the patient using, for example, the patient ID, patient name, or patient SSN. If the order is created for an existing patient (e.g., the patient ID matches the patient ID of the existing record), then system 110 preferably updates the patient's record in data store 220 with the newly created order. Otherwise, system 110 causes a new patient record to be created in data store 220 and causes the patient record to be populated with the data for the newly created order and other additional information as can be determined.

Within referral order management system 190, order processing engine 230 receives 430 the order and processes 440 the order. In one embodiment, processing of the order includes the following steps: validating the order and scheduling the procedure indicated in the order.

To validate the order, engine 230 preferably determines whether the received order contains enough information to support further processing of the order. In one embodiment, the received order has to include at least one of a patient name, ordered procedure ID, diagnosis, and requesting physician name. Otherwise, engine 230 rejects the order and generates an “incomplete order” event, which is communicated to referring provider system 110 via an event notification. Such a notification may be provided in the form of the electronic message.

If the order contains enough information to support further processing of the order, engine 230 within system 190 further performs scheduling of the order. As previously described, data store 220 maintains scheduling records 330. An exemplary scheduling record includes, for example, the following fields: a name of the resource, date and time when the resource is available, and order Id. A resource is an entity that is used to perform the procedure. A resource can be a room, a piece of equipment, or a physician required to perform the ordered procedure. If the resource has already been scheduled, the order ID, for example, is set to “1”. Alternatively, order ID is set to “0”. Thus, scheduling records for resource Cath Lab may look like the one shown in Table 1:

TABLE 1
Exemplary Scheduling Records

| Name of the | | | |
|---|---|---|---|
| Resource | Date | Time | Order ID |
| Cath Lab 1 | Jan. 2, 2005 | 5:15 p.m. | 1 |
| | Jan. 2, 2005 | 5:30 p.m. | |
| | Jan. 2, 2005 | 5:45 p.m. | |

In this example, Cath Lab 1 is not available at 5:15 p.m. because the order ID is set to “1”.

To schedule the procedure, order processing engine 230 queries data store 220 for the resources that can be used to perform the ordered procedure. Engine 230 loops through scheduling records for each resource and uses the following metrics such as the duration of the procedure and the requested date and time to find an available time slot for the ordered procedure. In one embodiment, engine 230 searches for consecutive records for a given resource having a cumulative duration of time equal or greater to the time specified in the order for the duration of the procedure. If engine 230 does not find an available time slot to schedule the procedure (e.g., the order ID is set to “1”), engine 230 searches scheduling records for another resource that can be used to perform the procedure until the available resource is found.

Those skilled in the art would appreciate that in other embodiments of the present invention an order may require that more than one resource be available for a procedure to be performed. For example, an order for a Cardiac Intra-Vascular Ultrasound (IVUS) procedure may require that the Cath Lab and the ultrasound equipment be available at the same time. To this end, engine 230 searches scheduling records for more than one resource to find an available time slot so as to schedule the procedure.

Once order processing engine 230 schedules the procedure indicated in the order, engine 230 stores the processed order in data store 220. Thus, data store 220 now stores the order along with the scheduled date and time, duration of the procedure, and the resource that will be used to perform the procedure.

As was previously described, certain actions performed on a specialty order by various entities can trigger events. Thus, when a new order is stored in data store 220, it triggers an event 450. System 190 notifies 460 referring provider system 110 of the event. Data store 220 keeps track of events that occur within system 190. As previously described, in one embodiment, an event is stored in the form of an event code, order ID, and a time stamp indicating when the event took place. Thus, when a new order is created at 5:00 p.m. on Nov. 23, 2004 having the order ID “12345” the following event will be stored in 310:

TABLE 2
Exemplary Events stored in Data Store 220.

| Time Stamp | Event Code | Order ID |
|---|---|---|
| Nov. 23, 2004 | NEWORDER | 12345 |
| 5:00 p.m. | | |

When a patient reports to a specialty department office at the time instructed in the specialty order, the office staff updates the order in the specialty department system 130. As the patient undergoes the procedure indicated in the order, the specialty department office staff monitors the status of the order and stores the status of the order into the system 130. For example, when the patient currently undergoes the procedure, the order status is “In-progress”; when the procedure is completed, the order status is “Completed”. In addition, specialty department staff adds results of the procedure to the order. The results are findings that are ascertained after the performance of the medical procedure. The specialty department staff can also include follow-up recommendations. For example, if the ordered procedure is a mammography-screening test, the findings may be abnormal tenderness of the breast tissue. The follow-up recommendation may be a biopsy. The specialty department staff enters the order status, the results, and follow-up recommendations to system 130. System 130 sends 470 to system 190 a message that preferably includes an order status, an order results, responsible physician, and suggested follow-up recommendations. In one implementation, system 130 updates data store 220 with the new order information.

When referral order management system 190 receives 470 status order updates or result order updates it triggers 480 an event. When an update to the status of the order is received, a new event is stored in events 310 in association with the order ID with the event code “ORDERUPDATE”. Similarly, when a change was filed on the order result, a new event is stored in events 310 in association with the order ID with an event code “RESULTUPDATE”. As previously described, each event in events 210 has a time stamp specifying the time when the event occurs. In addition, status of the order, results of the order, and follow-up recommendations are persisted to data store 220.

Notification engine 210 listens for data events. In one embodiment, engine 210 queries events 310 in data store 220 having a time stamp greater than the time stamp of the last query that was performed by engine 210.

In another embodiment, engine 210 subscribes to a message queue mechanism, such as Microsoft Message Queue or IBM MQ Services, to receive new events stored in events 310.

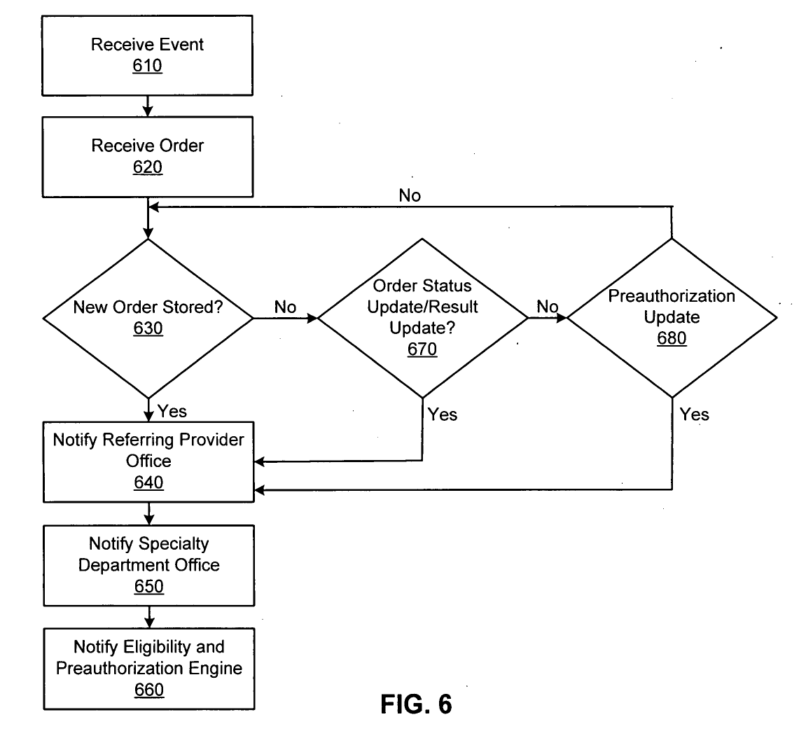

FIG. 6 is a flow diagram illustrating the steps performed by notification engine 210 according to one embodiment of the present invention. At step 610, engine 210 receives a new event. Engine 210 extracts the order ID from the event and queries data store 220 for data associated with the order having the extracted order ID. In response to the query, engine 210 receives the stored order 620, along with its results and updates, as well as insurance pre-authorization information (as will be described in more detail later). Engine 210 maintains business rules for routing events. As an illustrative example, a rule may indicate that if Event Code=NEWORDER, then route the event to system 110, system 130, and engine 240. If Event Code=ORDERUPDATE, then route the event to system 110. Engine 210 routes the events responsive to the rules. Thus, if the event code is NEWORDER 630, engine 210 notifies 640 referring provider system 110. Engine 210 also notifies 650 specialty department system 130. The notification includes the updated order. In one implementation, notifications can be sent using COM interfaces, web service calls, or via XML messages. When the referring provider office staff receives the results of the procedure, it enables the staff to initiate a new order request based on the text of the provided result. Engine 210 also notifies 660 eligibility and pre-authorization engine 240 (shown in FIG. 2).

If the event code is ORDERUPDATE or RESULTUPDATE 670, engine 210 notifies 640 referring provider system 110. If the event code is PREATHUPDATE, engine 210 notifies 640 referring provider system 110.

Referring again to FIG. 4, within referral order management system 190, eligibility and preauthorization engine 240 performs 485 eligibility verification and preauthorization. FIG. 5 is a flow diagram illustrating the steps performed by eligibility and pre-authorization engine 240. Those skilled in the art will recognize that alternative embodiments of engine 240 may perform the illustrated steps in different orders, perform additional steps, or even omit certain steps.

Engine 240 receives 510 a new event indicating that the new order is stored. Engine 240 also receives data associated with the order. Engine 240 determines 520 if insurance pre-authorization is required for the procedure indicated in the order. In one implementation, engine 240 uses the order ID indicated in the new event notification to determine the patient insurance carrier. Engine 240 determines whether the patient's insurance carrier requires pre-authorization for the procedure indicated in the order. If the insurance carrier requires pre-authorization for the procedure, engine 240 determines 540 whether the insurance carrier supports an electronic request for pre-authorization. If so, engine 240 communicates 550 the request for preauthorization to communication engine 250 within system 190. The request includes, for example, patient ID, ordered procedure, diagnosis ID, insurance carrier, and requesting physician name.

If the insurance carrier does not support an electronic request for pre-authorization, engine 240 does not enter a pre-authorization number and sets the “required preauthorization” flag to TRUE in orders 220. Engine 240 notifies 530 referring provider system 130 that verbal insurance authorization is required for the procedure indicated in the order.

If the insurance carrier does not require pre-authorization for a procedure indicated in the order, engine 240 does not enter a pre-authorization number in orders 340 and sets the “required preauthorization” flag to FALSE in orders 220. As part of the eligibility verification, engine 240 then determines 560 whether the procedure requires advanced beneficiary notice (ABN). In one implementation, engine 240 uses insurance data 350 in data store 220 to determine whether the insurance carrier reimburses for the procedure indicated in the order that needs to be performed in connection with a diagnosis indicated in the order. If the insurance carrier reimburses for the procedure for the diagnosis indicated in the order, then the “required ABN” flag in orders 310 is set 580 to FALSE. In the alternative, the “required ABN” flag is set to TRUE for this order, and engine 240 notifies 570 referral provider system 110 that the patient is required to sign the advance beneficiary notice, which indicates that the procedure will not be reimbursed by the insurance carrier and the patient is responsible for the payment.

In other implementations, engine 240 uses more complex eligibility rules to determine whether a certain procedure is eligible for reimbursement by insurance carrier. For example, eligibility rules may take into account the patient's age, gender and previous orders in considering whether or not a procedure will be reimbursed. For example, to be eligible for a mammography-screening test, a woman must be at a certain age before an insurance carrier will pay for one screening test every 2 years. Once a woman reaches 50 years old, insurance carriers typically pay for one screening annually. If a screening procedure has a result that indicates that a follow-up examination is necessary regardless of the age, the carrier will reimburse for additional procedures provided that the diagnosis requires so (e.g., suspicious abnormality found during physical exam). If a carrier elects not to reimburse the procedure, the patient may elect to have the procedure performed, provided the patient signs an ABN notice and pays for the procedure.

Referring again to FIG. 4, within referral order management system 190, communication engine 250 sends 490 a pre-authorization request to insurance carrier system 170. The request includes, for example, patient ID, insurance carrier, ordered procedure and diagnosis ID.

Insurance carrier system 170 receives 490 the preauthorization request and provides the response 492 to communication module 250 within referral order management system 190, which in turn sends the response to eligibility and pre-authorization engine 240. The response may include patient ID, ordered procedure, pre-authorization number, and a flag indicating whether the procedure will be reimbursed. Engine 240 associates the received information with the order ID and updates the order in data store 220 with the received information.

When referral order management system 190 receives 492 a preauthorization response, an event is triggered 494. The new event having an event code “PREATHUPDATE” in stored in events 310 in association with the order ID with a time stamp specifying the time when the event occurs. Notification engine 240 notifies 496 referring provider system 110 of the new event.

Thus, the present invention advantageously captures the initial specialty order, tracks the relevant patient information regarding the order, provides automated alerts to physicians and other healthcare, professionals when a new order information is available, communicates the order results, and follows up with the subsequent recommendations and results of the ordered diagnostic tests or therapeutic procedures without paper-based communication with the specialty department office. Thus, some of the benefits of the present invention are in that it significantly reduces paper-based communications between specialty service providers and referrers to initiate a specialty order and complete services prescribed in the order. In addition, the present invention lightens medical staff workload by automating a scheduling procedure.

1. A digital medical referral management system for automatically monitoring a specialty referral order received from a referring provider system, the system comprising:
an order processing engine for processing the received order and storing the order in the referral order management system;
a data store engine for receiving subsequent modifications to the order; and
a notification module for notifying the referring provider system of the subsequent modifications to the order.

2. The system of claim 1, wherein the order includes an ordered procedure to be performed on a patient, and wherein the processing module is further adapted to validate the received order, schedule the ordered procedure, and update the stored order with the scheduled procedure.

3. The system of claim 2, wherein the data store engine is further adapted to store mappings between medical procedures and resources to be used to perform the procedures; and wherein scheduling the ordered procedure further comprises identifying an available resource to be used to perform the ordered procedure.

4. The system of claim 1, wherein the order includes an ordered procedure to be performed on a patient and the data store engine stores an indication of whether a medical procedure requires preauthorization by an insurance carrier system, and wherein the system further comprises:
an eligibility and preauthorization module for using the indication to determine whether preauthorization is required for performing the procedure indicated in the order and requesting the preauthorization in response to the determination.

5. The system of claim 4, wherein the eligibility and preauthorization module is further adapted to determine whether the requesting step can be done electronically, and wherein the notification module is further adapted to notify the referring provider system in response to the determination that the requesting cannot be done electronically.

6. The system of claim 4, wherein the eligibility and preauthorization module is further adapted to receive from the insurance carrier system a preauthorization response and store the response in the data store in association with the order.

7. The system of claim 4, wherein the data store engine further maintains mappings between insurance carriers and medical procedures eligible by reimbursement by insurance carriers and wherein the eligibility and preauthorization module is further adapted to use the mappings to determine whether the procedure indicated in the order is eligible for reimbursement by an insurance carrier associated with a patient for whom the order is created.

8. The system of claim 7, wherein the notification module is further adapted to notify the referral provider system responsive to the determination that the procedure indicated in the order is not eligible for reimbursement by the insurance carrier.

9. The system of claim 1, wherein subsequent modifications to the order specify an order status update, and wherein the notification module is further adapted to notify the referring provider system of the order status update.

10. The system of claim 1, wherein subsequent modifications to the order specify an order results update, and wherein the notification module is further adapted to notify the referring provider system of the order results update.

11. The system of claim 1, wherein subsequent modifications to the order specify an update to order preauthorization information, and wherein the notification module is further adapted to notify the referring provider system of the update to the order preauthorization information.

12. The system of claim 1, wherein the notification module is further adapted to notify the referring provider office of the processed order.

13. The system of claim 1, wherein subsequent modifications to the order specify follow up recommendations to the order, and wherein the notification module is further adapted to notify the referring provider office of the follow up recommendations to the order.

14. The system of claim 1, wherein the referral order management system is in communication with a specialty department system adapted to provide subsequent modifications to the order to the referral order management system, and wherein the notification module is further adapted to notify the specialty department system of the processed order.

15. The system of claim 1, wherein subsequent modifications to the order specify at least one of an order status update, order result update, and an update to an order preauthorization information.

16. The system of claim 1, wherein the data store engine maintains subsequent modifications to the order in the form of events, each event is associated with an identification of the order having modifications that triggered the event, an event type, and a time stamp indicating when the event occurred; and wherein the notification module is further adapted to query the data store for events having a time stamp greater than a time stamp of events of which a notification has been provided and use the identification of the order to notify the referring provider office of the events.

17. The system of claim 4, wherein the data store engine further maintains various data representations utilized by the insurance carrier system, and wherein the system further comprises a communication module adapted to map the preauthorization request to the representation utilized by the insurance carrier system and forward the request to the insurance carrier system.

18. A method performed by a medical referral management system for automatically monitoring an order received from a referring provider system, the method comprising:
processing the received order and storing the order in the referral management system;
receiving subsequent modifications to the order; and
notifying the referring provider system of the subsequent modifications to the order.

19. The method of claim 18, wherein subsequent modifications to the order specify at least one of an order status update, order result update, and an update to an order preauthorization information.

20. The method of claim 18, wherein subsequent modifications to the order specify that an order status has been updated, and wherein the method further comprises notifying the referring provider system that the order status has been updated.

21. The method of claim 18, wherein subsequent modifications to the order specify an order status update, and wherein the method further comprises notifying the referring provider system of the order status update.

22. The method of claim 18, wherein subsequent modifications to the order specify an order results update, and wherein the method further comprises notifying the referring provider system of the order result update.

23. The method of claim 18, wherein subsequent modifications to the order specify an update to order preauthorization information, and wherein the method further comprises notifying the referring provider system of the update to order preauthorization information.

24. The method of claim 18, wherein the order includes an ordered procedure to be performed on a patient, and wherein processing of the order further comprises:
validating the received order;
scheduling the ordered procedure; and
updating the stored order with the scheduled procedure.

25. The method of claim 18, further comprising:
storing subsequent modifications to the order in the form of events, an event is associated with an event type; and
providing the notifications of subsequent modifications to the order responsive to the type of the event.

26. The method of claim 18, further comprising:
storing subsequent modifications to the order in the form of events, an event is associated with an event type and a time stamp indicating when the event occurred; and
querying for the events having a time stamp greater than a time stamp of events of which a notification has been provided.

27. The method of claim 18, wherein processing of the order further includes scheduling a procedure indicated in the order, and wherein the method further comprises notifying the referring provider office that the procedure has been scheduled for the order.

28. The method of claim 18, wherein subsequent modifications of the order specify follow up recommendations to the order, and wherein the method further comprises notifying the referring provider office of the follow up recommendations to the order.

29. The method of claim 18, wherein the referral order management system is in communication with a specialty department system adapted to communicate subsequent modifications to the order to the referral order management system, and wherein the method further comprises notifying the specialty department system of the processed order.

30. The method of claim 18, wherein the referral order management system further comprises an eligibility and preauthorization module adapted to determine whether a procedure indicated in the order requires preauthorization, and wherein the method further comprises notifying the eligibility and preauthorization module of the processed order.

31. The method of claim 18, wherein the referral order management system is in communication with an insurance carrier system, and wherein the method further comprises:
sending an insurance preauthorization request to the insurance carrier system.

32. A computer program product comprising:
a computer-readable medium having computer program code embodied therein for automatically monitoring an order received by a referral management system from a referring provider system, the computer program code adapted to:
process the received order and store the order in the referral management system;
receive subsequent modifications to the order; and
notify the referring provider system of the subsequent modifications to the order.

33. The computer program code of 32, wherein subsequent modifications to the order specify at least one of an order status update, order result update, and an update to an order preauthorization information.

34. The computer program code of 32, wherein subsequent modifications to the order specify that an order status has been updated, and wherein the computer program code further adapted to notify the referring provider system that the order status has been updated.

35. The computer program code of 32, wherein subsequent modifications to the order specify an order status update, and wherein the computer program code is further adapted to notify the referring provider system of the order status update.

36. The computer program code of 32, wherein subsequent modifications to the order specify an order results update, and wherein the computer program code is further adapted to notify the referring provider system of the order result update.

37. The computer program code of 32, wherein subsequent modifications to the order specify an update to order preauthorization information, and wherein the computer program code is further adapted to notify the referring provider system of the update to order preauthorization information.

38. The computer program code of 32, wherein the order includes an ordered procedure to be performed on a patient, and wherein processing of the order further comprises:
validating the received order;
scheduling the ordered procedure; and
updating the stored order with the scheduled procedure.

39. The computer program code of 32, further comprising:
storing subsequent modifications to the order in the form of events, an event is associated with an event type; and
providing the notifications of subsequent modifications to the order responsive to the type of the event.

40. The computer program code of 32, further comprising:
storing subsequent modifications to the order in the form of events, an event is associated with an event type and a time stamp indicating when the event occurred; and
querying for the events having a time stamp greater than a time stamp of events of which a notification has been provided.

41. The computer program code of 32, wherein processing of the order further includes scheduling a procedure indicated in the order, and wherein the method further comprises notifying the referring provider office that the procedure has been scheduled for the order.

42. The computer program code 32, wherein subsequent modifications of the order specify follow up recommendations to the order, and wherein the computer program product is further adapted to notify the referring provider office of the follow up recommendations to the order.

43. The computer program 32, wherein the referral order management system is in communication with a specialty department system adapted to communicate subsequent modifications to the order to the referral order management system, and wherein the computer program code is further adapted to notify the specialty department system of the processed order.
